(19) United States
(12) Patent Application Publication
(10) Pub. No.: US 2013/0176289 A1
(43) Pub. Date: Jul. 11, 2013

(54) DISPLAY SWITCH METHOD AND PORTABLE DEVICE THEREOF

(71) Applicants: Jing-Fu Chen, Taipei City (TW); Ting-Yi Kuo, Taipei City (TW)

(72) Inventors: Jing-Fu Chen, Taipei City (TW); Ting-Yi Kuo, Taipei City (TW)

(73) Assignee: ASUSTeK COMPUTER INC., Taipei City (TW)

(21) Appl. No.: 13/736,966

(22) Filed: Jan. 9, 2013

Related U.S. Application Data
(60) Provisional application No. 61/584,822, filed on Jan. 10, 2012.

(30) Foreign Application Priority Data
Dec. 17, 2012 (TW) 101147902

(51) Int. Cl. G09G 5/00

(52) U.S. Cl. CPC G09G 5/003
USPC 345/204

(57) ABSTRACT

A display switch method for a portable device and an electronic device which are coupled to each other. In the method, when the portable device is coupled to the electronic device, the portable device stores a current operation status of the portable device according to a display switching signal. According to the hardware parameters of the display of the electronic device, the portable device adjusts a display setting. According to the stored operation status and the display setting, a first operation frame displayed on the portable device is changed to be a second operation frame displayed by a display of the electronic device.

### CROSS-REFERENCE TO RELATED APPLICATION

This application claims the priority benefits of U.S. provisional application Ser. No. 61/584,822, filed on Jan. 10, 2012 and Taiwan application serial no. 101147902, filed on Dec. 17, 2012. The entirety of each of the above-mentioned patent applications is hereby incorporated by reference herein and made a part of this specification.

### BACKGROUND OF THE INVENTION

1. Field of Invention

The present disclosure relates to a displaying method and a portable device. More particularly, the present disclosure relates to a display switch method and a portable device.

2. Description of Related Art

With the continuous development of the functionalities and convenience of mobile devices, such as smart phones or tablet computers, the mobile devices have become the essential electronic products in daily life. A user not only utilizes the mobile device to share information or chat on-line anytime, but also installs various applications into the mobile device and obtains various services by executing the applications.

However, it is rare to integrate two or more mobile devices in different sizes and to change the frame between two or more displays. In addition, even the frames can be switched between two or more displays, the frames displayed by the display with different specifications or the operation procedure of the application are not adequately adjusted with the display specifications of the displays in use for displaying the frames. That is, it is impossible to display the layouts and to provide the operation procedures which are respectively corresponding to the different specifications of the displays while the operation frame is changed to be displayed between different displays. Moreover, during the display switch procedure, the display setting of the operating system is not changed with the specifications of the displays in use. Hence, the displayed frame cannot truly reflect the displaying performance of the display.

### SUMMARY OF THE INVENTION

The present disclosure is to provide a display switch method and a portable device. By using the display switch method of the present disclosure, when the portable device is coupled to an electronic device to form a hybrid mobile device, the operation frame displayed by the portable device is changed to a new operation frame displayed by a display of the electronic device. The display switch method of the present disclosure is capable of re-organizing the operation frame according to the hardware specification of the display of the hybrid mobile device to express the optimized performance of the displaying.

The disclosure provides a display switch method for a hybrid mobile device comprising a portable device and an electronic device, wherein the portable device displays a first operation frame. The display switch method comprises when the portable device is coupled to the electronic device, triggering a display switching signal by the portable device. According to the display switching signal, the portable device stores an operation status. According to a hardware parameter of the electronic device, the portable device adjusts a display setting. According to the stored operation status and the display setting, the display of the electronic device displays a second operation frame according to the first operation frame displayed by the portable device.

According to one embodiment of the disclosure, the first operation frame and the second operation frame commonly correspond to the operation status.

According to one embodiment of the disclosure, after the portable device adjusts the display setting, the method further comprises loading an application graphic file and an application layout file included in the display setting.

According to one embodiment of the disclosure, after the portable device adjusts the display setting, the method further comprises loading a system graphic file and a system layout file included in the display setting and organizing at least a system interface on a display of the electronic device corresponding to the adjusted display setting.

The disclosure also provides a portable device comprising: a display unit, a connection port and a processor. The display unit displays a first operation frame. The connection port sends a display switching signal after connecting to an electronic device. The processor, according to the display switching signal, stores an operation status and, according to a hardware parameter of a display of the electronic device, adjusts a display setting, wherein according to the stored operation status and the display setting, the portable device changes the first operation frame into a second operation frame displayed by a display of the electronic device.

According to one embodiment of the disclosure, the first operation frame and the second operation frame commonly correspond to the operation status of the portable device.

According to one embodiment of the disclosure, after adjusting the display setting, the processor further loads a display setting of an operating system and loads an application graphic file and an application layout file included in the adjusted display setting.

According to one embodiment of the disclosure, after adjusting the display setting, the processor further loads a system graphic file and a system layout file included in the display setting and organizes at least a system interface on the display of the electronic device corresponding to the adjusting display setting.

Accordingly, in the present disclosure, the portable device and the hybrid mobile device in which the portable device is coupled to the electronic device commonly share the same database. During the display switch procedure (the operation frame is switched from being displayed by the display unit of the portable device to being displayed by the display of the hybrid mobile device), the operating system adjust the display setting according to the hardware parameters/hardware specification of the display. Therefore, the operation frame (including the operation frame of the application and the desktop frame) displayed by the display corresponds to the adjusted display setting.

Hence, after the display switch procedure is completed, the frame displayed by the display of the hybrid mobile device full fills the display setting so as to express the optimized performance of the display. Moreover, the operation status of the application which is currently run by the portable device before the portable device is coupled to the electronic device is completely preserved and resumed through the operation frame displayed by the display of the hybrid mobile device after the display switch procedure is completed. Thus, the user can keep on operating the application at the stored operation status on the hybrid mobile device which comprised of the portable device and the electronic device.

It is to be understood that both the foregoing general description and the following detailed description are exemplary, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram showing a portable device according to one embodiment of the disclosure.

FIG. 2A and FIG. 2B are schematic assembly diagrams respectively before and after the hybrid mobile device is assembled according to one embodiment of the disclosure.

FIG. 3 is a flow chart illustrating a display switch method according to one embodiment of the disclosure.

FIG. 4A is a schematic diagram showing an application operation frame displayed on a display unit of a portable device.

FIG. 4B is a schematic diagram showing an application operation frame displayed on a display of a hybrid mobile device.

FIG. 5 is a flow chart illustrating steps of resetting a system graphic file and a system layout and drawing interface elements in a display switch method according to one embodiment of the disclosure.

### DESCRIPTION OF THE PREFERRED EMBODIMENTS

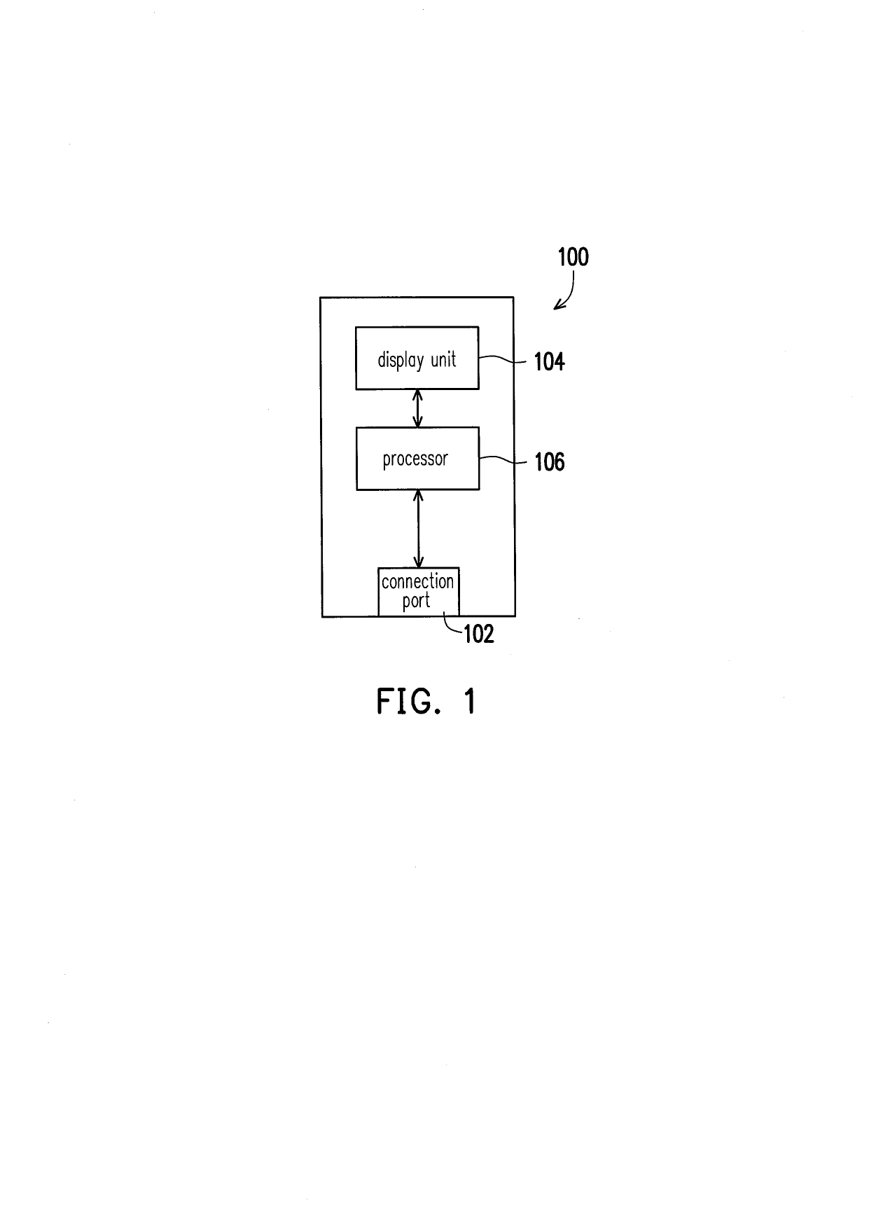

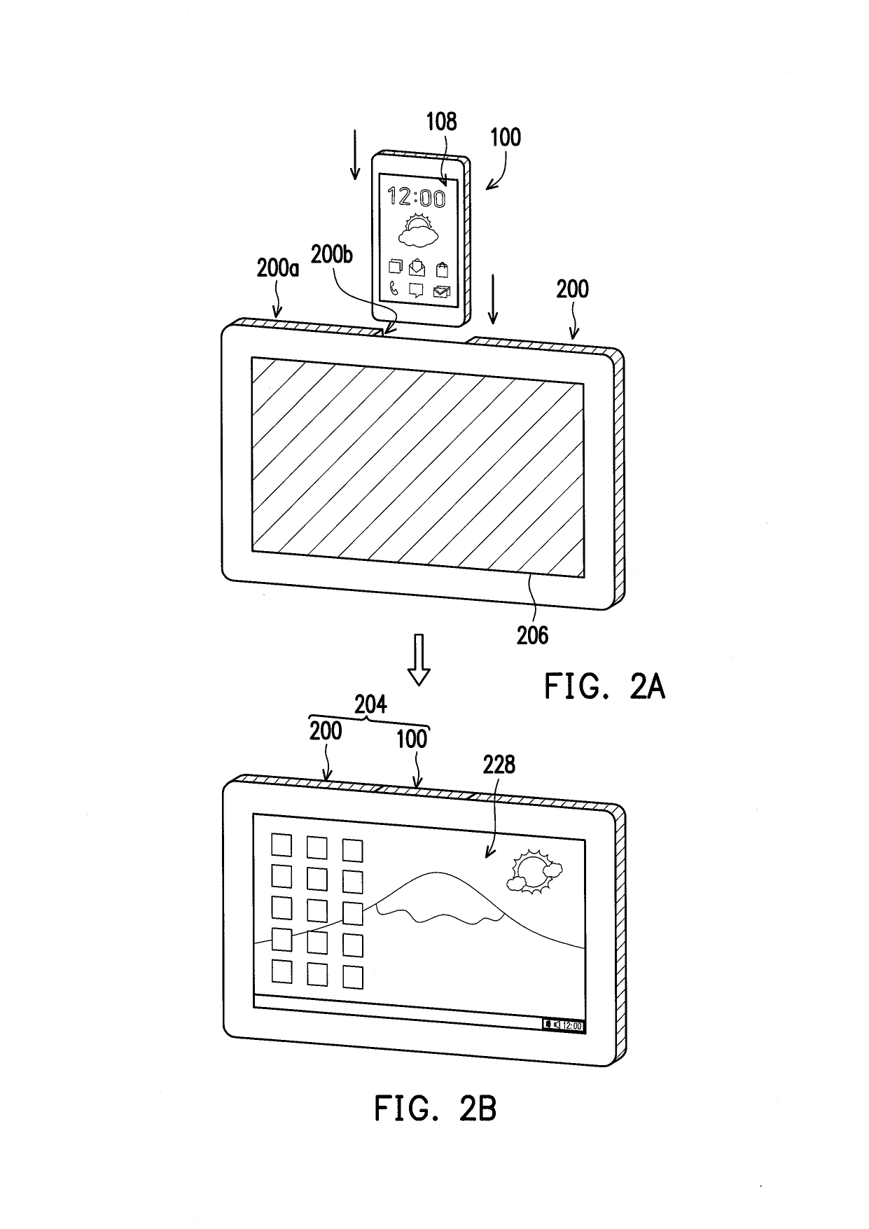

FIG. 1 is a schematic diagram showing a portable device according to one embodiment of the disclosure. FIG. 2A and FIG. 2B are schematic assembly diagrams respectively before and after the hybrid mobile device is assembled according to one embodiment of the disclosure.

As shown in FIG. 1, the portable device 100 of the present embodiment can be, for example, a mobile phone including cell phone, smart phone, or personal digital assistant. The portable device 100, such as a tablet, comprises a connection port 102, a display 104 and a processor 106.

As shown in FIG. 1, FIG. 2A and FIG. 2B, the portable device 100 is coupled to an electronic device 200 through the connection port 102 so that the portable device 100 and the electronic device 200 are coupled to each other to be a hybrid mobile device 204. The electronic device 200 can be a tablet having a display 206 or a cell phone or a computer having relatively large screen. The electronic device 200 can receive the control signal from the portable device 100 to display the operation frame, which is transmitted from the portable device 100, on the display 206 after the electronic device 200 is coupled with the portable device 100.

For instance, the resolution of the display 104 of the portable device 100 is 1280×720 and the resolution of the display 206 of the electronic device 200 is 2048×1536 through 2560×1600. It should be noticed that the size of the display 104 of the portable device 100 is different from the size of the display 206 of the electronic device 200.

Moreover, on the rear surface 200a of the electronic device 200 opposite to the surface assembled with the display 206, there are socket (not shown) and sliding tracks 200b. Hence, the portable device 100 can plug into the socket along the sliding tracks 200b and can be coupled to the electronic device 200 through the connection port 102 to form the hybrid mobile device 204 (as shown in FIG. 2B).

This hybrid mobile device 204 can be a tablet, for example. Therefore, when the portable device 100 and the electronic device 200 are coupled to each other, the user can operate the portable device 100 through the display 206 of the electronic device 200. For instance, the user can operates the portable device 100 through touch screen of the electronic device 200 to watch the movies, make phone calls, edit emails or play games.

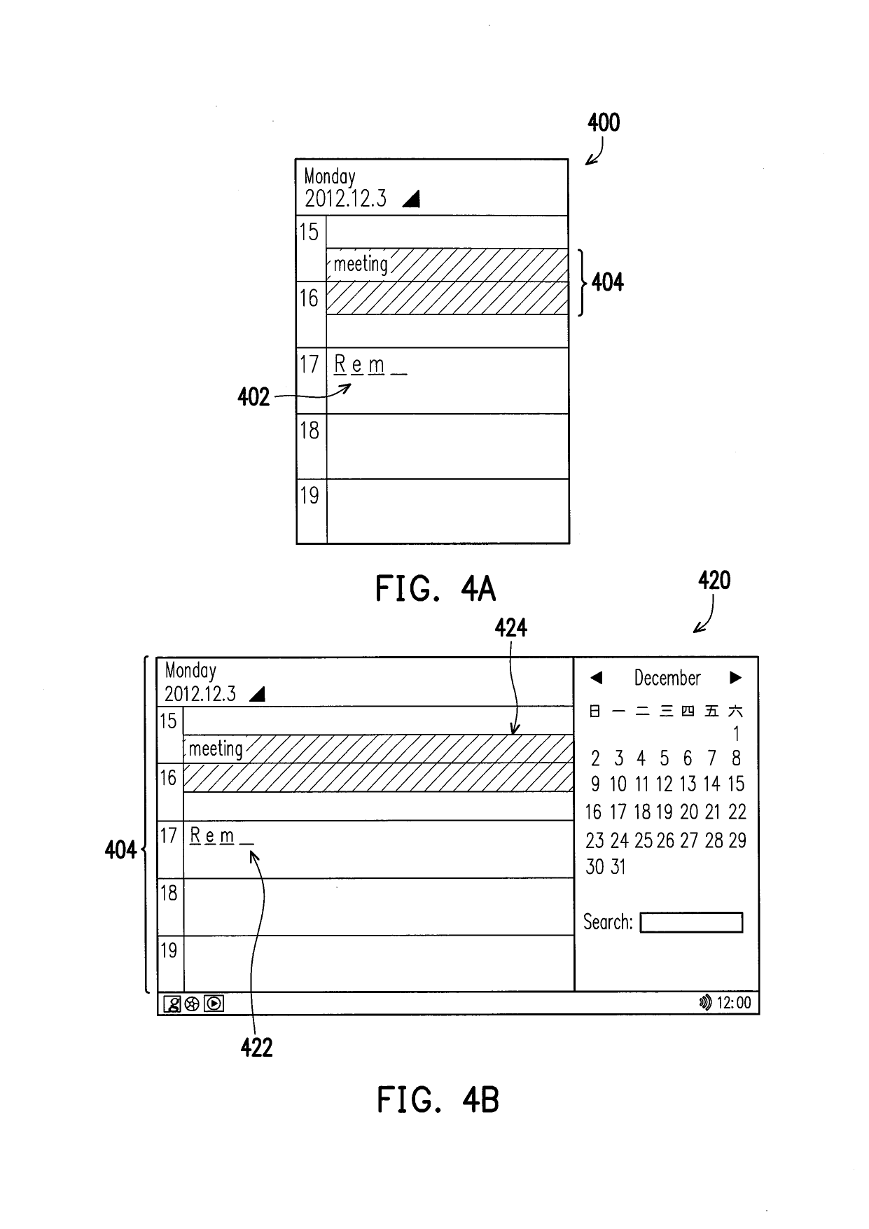

The portable device 100 runs an operating system, a plurality application and has a processor. The portable device 100 can executes an application alone and has the display 104 to display a first operation frame of the application or the first operation frame of operating system (such as the calendar APP operation frame 400 which includes the preview portion 402 currently in compilation and shown in FIG. 4A).

In the present embodiment, the processor 106 can be, for example, a micro-controller, an embedded controller or a central processing unit (CPU).

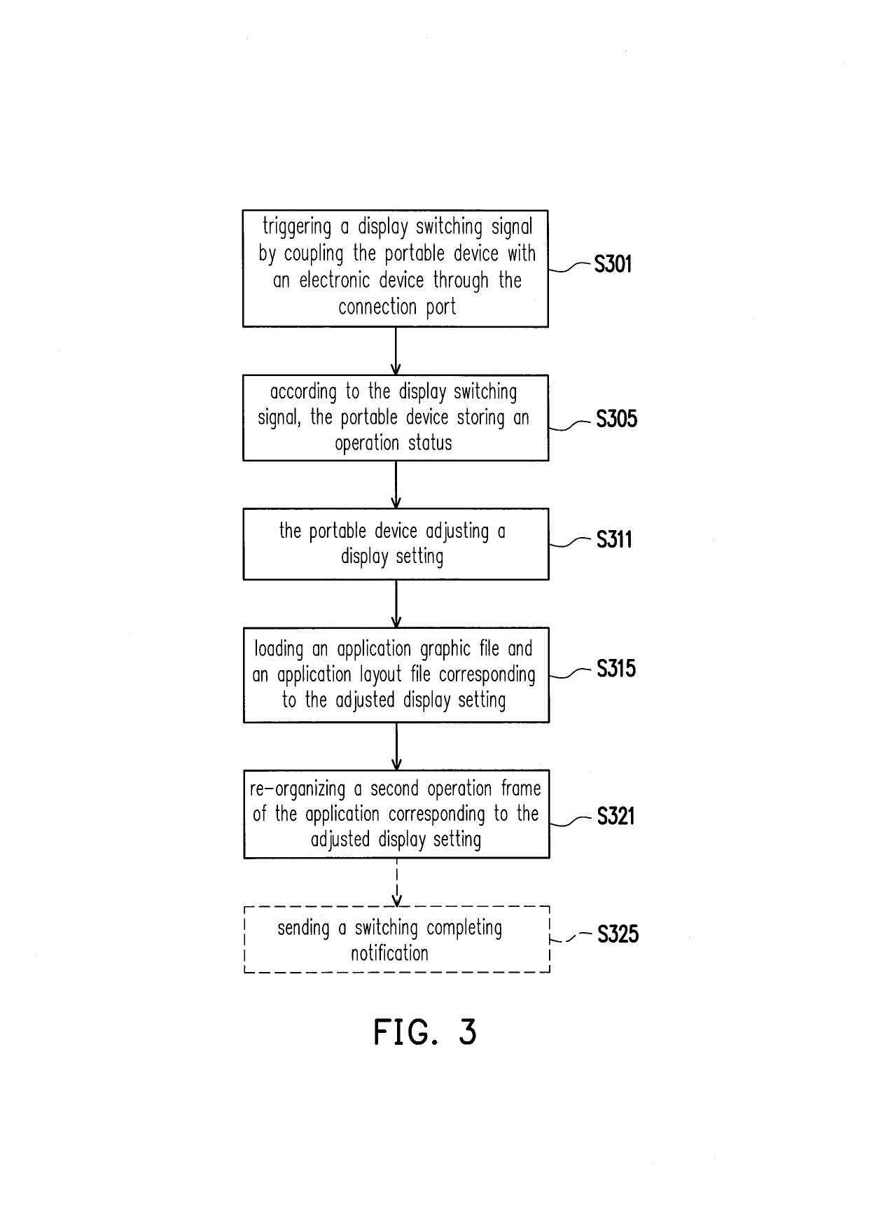

FIG. 3 is a flow chart illustrating a display switch method according to one embodiment of the disclosure. As shown in FIG. 1, FIGS. 2A through 2B and FIG. 3, in the step S301, a display switching signal is triggered by the portable device 100 coupled to the electronic device 200 through the connection port 102. That is, the frame displayed by the display 104 of the portable device 100 is changed to be displayed by the display 206 of the electronic device 200.

In the step S305, according to the display switching signal, the portable device 100 stores an operation status of the application or the operating system currently executed. The operation status comprises the content information of the application currently executed by the portable device 100. For instance, when playing the audio/video file, the content information comprises the playing time, the number of the played frames or various appearances of the application in run.

Thereafter, according to a hardware parameter of the display 206 of the electronic device 200, the operation frame of the application displayed by the display 104 of the portable device 100 (i.e. the first operation frame) is changed to be another operation frame (a second operation frame) displayed by the display 206 of the electronic device 200, wherein the another operation frame is corresponding to the hardware parameter of the display. For instance, as shown in FIGS. 4A through 4b, when the portable device 100 executes the calendar application (app), the display 104 of the portable device 100 displays the application operation frame (i.e. the first operation frame).

When the portable device 100 executes the calendar application (app) and is directly coupled to the electronic device 200, the display 206 of the electronic device 200 displays the operation frame (i.e. the second operation frame) of the calendar application (app) currently executed by the portable device 100. Noticeably, although the portable device 100 executes the same calendar application (app), the first operation frame displayed by the display 104 of the portable device 100 is apparently different from the second operation frame displayed by the display 206 of the electronic device 200. The displayed second operation frame is a result of re-organizing the operation frame of the calendar application (app) according to the current hardware parameter.

As shown in FIG. 3, in the step S311, according to the hardware parameter of the display 206 of the electronic device 200, a display setting of the operating system run by the portable device 100 is adjusted. The hardware parameter comprises the resolution of the display 206 of the electronic device 200, a dots-per-inch (DPI) value of the display 206 of the electronic device 200 or the color depth of the display 206 of the electronic device 200.

In the step S315, an application graphic file and an application layout file corresponding to the adjusted display setting are loaded. For instance, the operating system re-loads the application graphic file and the application layout file corresponding to the current display setting. Moreover, in one embodiment, the application graphic file and the application layout file can be, for example, included in the display setting. Furthermore, as shown in FIG. 4B, the display 206 of the hybrid mobile device 204 (i.e. the display 206 of the electronic device 200) displays the calendar drawing of the operation frame 420 of the calendar application (such as the 24-hour-time slots shown at the left-hand side of the operation frame 420 of the calendar application or the calendar background picture (not shown)) and the calendar layout of the operation frame 420 of the calendar application (such as the arrangement frames of the operation frame 420 of the calendar application) which are both corresponding to the adjusted display setting.

In the step S321, according to the stored operation status of the application in run, a second operation frame of the application corresponding to the adjusted display setting are re-organized or re-drawn on the loaded application graphic file and the loaded application layout file, so that the first operation frame displayed on the portable device 100 (as the operation frame 400 of the calendar application shown in FIG. 4A) is changed to be the second operation frame of the application displayed by the display 206, wherein the second operation frame (such as the operation frame 420 of the calendar application) is corresponding to the adjusted display setting. In an embodiment, the way to re-draw can be downloading an image from website or generating an image from the system to fit the second operation frame, but not limited herein.

Noticeably, the first operation frame and the second operation frame commonly correspond to the operation status of the application or the operation system currently executed by the portable device (for instance, the portion 402 in FIG. 4A which is currently in compilation corresponds to the portion 422 in FIG. 4B which is currently in compilation) and both of them display the same data content (for instance, the portion 402 currently in compilation and the already edited portion 404 shown in FIG. 4A are respectively corresponding to the portion 422 currently in compilation and the already edited portion 424 shown in FIG. 4B).

In other words, the portable device 100 and the hybrid mobile device 204 which is assembled by coupling the portable device 100 and the electronic device 200 commonly uses the same database. In the ways of displaying the application frames, in order to response to different display setting of the bottom layer of the operating system, the application graphic files and layouts respectively corresponding to different display settings are respectively loaded to the display 104 of the portable device 100 and the display 206 of the hybrid mobile device 204. Furthermore, according to the stored operation status of the application in execution, the operation frame of the application is re-organized or re-drawn on the loaded application graphic file and the loaded application layout file corresponding to the display setting. Hence, the portable device 100 can be directly coupled to the electronic device 200 without being turned off or restarted and the operation frame (such as the operation frame 400 of the calendar application shown in FIG. 4A) of the application displayed by the display 104 of the portable device 100 can be smoothly converted/switched to be the operation frame (such as the operation frame 420 of the calendar application shown in FIG. 4B) of the application displayed by the display 206 of the hybrid mobile device 204. In an embodiment, the way to re-draw can be downloading an image from website or generating an image from the system to fit the second operation frame, but not limited herein.

Moreover, the display format of the second operation frame after the display switch procedure corresponds to the adjusted display setting of the bottom layer of the operating system so that the display capability of the large size display of the hybrid mobile device can be impressively expressed.

In another embodiment, after the step S321 of re-organizing the second operation frame of the application, the displaying switching method of the previous embodiment further comprises a step S325 of sending a switching completing notification by the operating system. For instance, during the display switch procedure, the display 206 of the hybrid mobile device/electronic device dims the light of the display 206 or displays a waiting window and, after the second operation frame of the application is organized, the light of the display 206 is tune up or the waiting window is closed to remind the user that the display switch procedure is done.

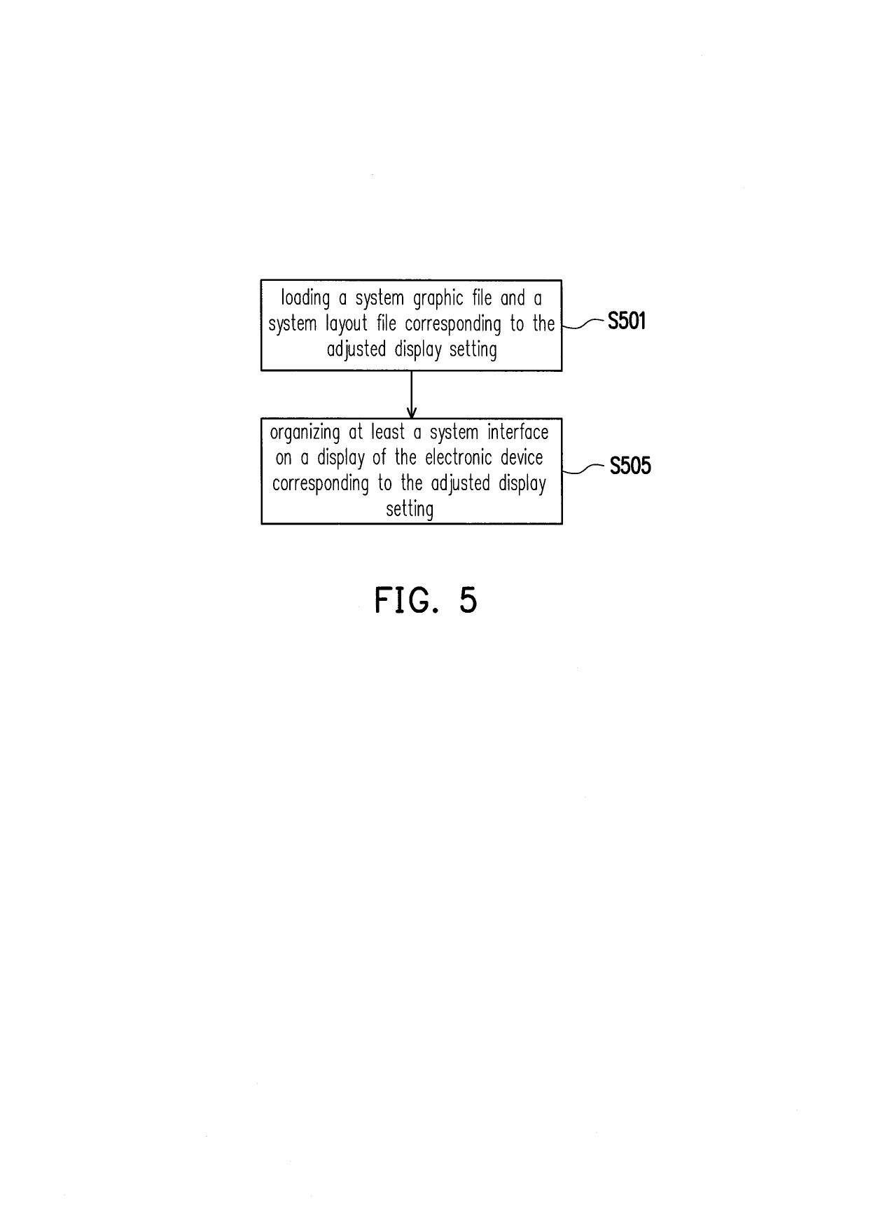

FIG. 5 is a flow chart illustrating steps of resetting a system graphic file and a system layout and organizing interface elements in a display switch method according to one embodiment of the disclosure. As shown in FIG. 5, in the previous embodiment, after the step S311 of adjusting the display setting of the operating system and before the step S315 of loading the application graphic file and the application layout file, the display switch method further comprises initiating a window management module by the operating system, loading a system graphic file and a system layout file corresponding to the adjusted display setting by the window management module (step S501) and re-organizing at least one system interface (such as the status bar or the permanent buttons) corresponding to the adjusted display setting on the display 206 by the window management module (step S505).

In the aforementioned embodiment, under the circumstance that the display 104 of the portable device 100 is currently displaying the first operation frame of the application, the portable device 100 is coupled to the electronic device 200 to invoke the display switch procedure between the display 104 and the display 206, which is used to elaborate that the portable device and the hybrid mobile device commonly use the same database and, according to different hardware specification, the display setting of the bottom layer of the operating system is accordingly modified and the application graphic file and the application layout file corresponding to the adjusted display setting are reloaded and the second operation frame corresponding to the adjusted display setting is displayed on the display 206. However, the present disclosure is not limited to the description mentioned above. Taking that the display 104 of the portable device 100 displays the main page frame (such as the main page frame 108 shown in FIG. 2A) as an example, when the portable device 100 is coupled to the electronic device 200 to invoke the display switch procedure between the display 104 and the display 206, a desktop frame (such as the desktop frame 228 shown in FIG. 2B) corresponding to the adjusted display setting is directly re-loaded after the step S311 of adjusting the display setting of the operating system.

Moreover, the display switch method (steps S301˜S325 and S501˜S505) mentioned in the previous embodiment can be implemented by the processor 106 of the portable device 100 or the processor 106 of the portable device 100 in the hybrid mobile device 204 executing the aforementioned steps.

Altogether, in the present disclosure, the portable device and the hybrid mobile device in which the portable device is coupled to the electronic device commonly share the same database. During the display switch procedure (the operation frame is switched from being displayed by the display unit of the portable device to being displayed by the display of the hybrid mobile device), the operating system adjust the display setting according to the hardware parameters/hardware specification of the display. Therefore, the operation frame (including the operation frame of the application and the desktop frame) displayed by the display corresponds to the adjusted display setting. Hence, after the display switch procedure is completed, the frame displayed by the display of the hybrid mobile device full fills the display setting so as to express the optimized performance of the display.

Moreover, the operation status of the application which is currently run by the portable device before the portable device is coupled to the electronic device is completely preserved and resumed through the operation frame displayed by the display of the hybrid mobile device after the display switch procedure is completed. Thus, the user can keep on operating the application at the stored operation status on the hybrid mobile device which comprised of the portable device and the electronic device.

It will be apparent to those skilled in the art that various modifications and variations can be made to the structure of the present disclosure without departing from the scope of the disclosure. In view of the foregoing descriptions, it is intended that the present disclosure covers modifications and variations of this disclosure if they fall within the scope of the following claims and their equivalents.

What is claimed is:

1. A display switch method for a hybrid mobile device comprising a portable device and an electronic device, wherein the portable device displays a first operation frame, the display switch method comprising:
when the portable device is coupled to the electronic device, the portable device triggering a display switching signal;
according to the display switching signal, the portable device storing an operation status;
according to a hardware parameter of the electronic device, the portable device adjusting a display setting; and
according to the stored operation status and the display setting, the display of the electronic device displaying a second operation frame according to the first operation frame displayed by the portable device.

2. The display switch method of claim 1, wherein the first operation frame and the second operation frame commonly correspond to the operation status of the portable device.

3. The display switch method of claim 1, after the portable device adjusting the display setting, further comprising:
loading an application graphic file and an application layout file included in the display setting.

4. The display switch method of claim 1, after the portable device adjusting the display setting, further comprising:
loading a system graphic file and a system layout file included in the display setting; and
organizing at least a system interface on a display of the electronic device corresponding to the adjusted display setting.

5. The display switch method of claim 1, wherein the hardware parameter comprises a resolution of a display of the electronic device, a dots-per-inch (DPI) value of the display of the electronic device or a color depth of the display of the electronic device.

6. The display switch method of claim 1, wherein the display setting comprises a resolution, a DPI value or a color depth.

7. The display switch method of claim 1, further comprising sending a switching completing notification.

8. A portable device, comprising:
a display unit displaying a first operation frame;
a connection port sending a display switching signal after connecting to an electronic device; and
a processor, according to the display switching signal, storing an operation status and, according to a hardware parameter of a display of the electronic device, adjusting a display setting according to the stored operation status and the display setting, the display of the electronic device displaying a second operation frame according to the first operation frame of the portable device.

9. The portable device of claim 8, wherein the first operation frame and the second operation frame commonly correspond to the operation status of the portable device.

10. The portable device of claim 8, wherein, after adjusting the display setting, the processor further loads an application graphic file and an application layout file included in the adjusted display setting.

11. The portable device of claim 8, wherein after adjusting the display setting, the processor further loads a system graphic file and a system layout file included in the display setting and organizes at least a system interface on the display of the electronic device corresponding to the adjusted display setting.

12. The portable device of claim 8, wherein the display setting comprises a resolution, a DPI value or a color depth.

13. The portable device of claim 8, wherein the hardware parameter comprises a resolution of the display of the electronic device, a DPI value of the display of the electronic device or a color depth of the display of the electronic device.

14. The portable device of claim 8, wherein after the second operation frame corresponding to the adjusted display setting is displayed by the display, the processor further sends a switching completing notification.
